(19) United States
(12) Patent Application Publication
(10) Pub. No.: US 2025/0241823 A1
(43) Pub. Date: Jul. 31, 2025

(54) EASY-TO-USE MASSAGER

(71) Applicant: Jianbin Zhou, Ji'an City (CN)

(72) Inventor: Jianbin Zhou, Ji'an City (CN)

(21) Appl. No.: 19/183,697

(22) Filed: Apr. 18, 2025

(30) Foreign Application Priority Data
Apr. 3, 2025 (CN) 202520629698.7

(51) Int. Cl. A61H 23/02; A61H 19/00

(52) U.S. Cl. CPC A61H 23/0254; A61H 19/34; A61H 2201/0107; A61H 2201/1207; A61H 2201/1635; A61H 2201/164; A61H 2201/165; A61H 2201/1695; A61H 2205/065; A61H 2205/12

(57) ABSTRACT

An easy-to-use massager, includes: a massage member including a massage body and an annular body, where the massage body includes a massage portion and a massage potential energy generating device built in the massage portion, a surface of the massage portion is provided with a massage surface, and an inner periphery of the annular body is provided with an opening region; and a connecting assembly respectively connected with the massage body and the annular body to hold the massage member for massage by wearing the connecting assembly. By adopting the above solution, provided is an easy-to-use massager that can be used without holding by a hand by fitting a massage member to a human body part to be massaged, and being worn on a user's body by a connecting assembly.

### TECHNICAL FIELD

The present invention belongs to the field of massagers, and in particular relates to an easy-to-use massager.

### BACKGROUND

Massagers are used to massage acupoints on the human body to achieve the function of health preservation and health maintenance. Common massage parts include, for example, women's private parts, palms, fingers, soles of the feet and other parts.

Existing massagers typically include a massage part and a hand-held part, allowing users to massage by holding the hand-held part and fitting the massage part to the human body part to be massaged.

However, hand-held use is only suitable for a short period of time, while long-term holding will cause arm soreness.

### SUMMARY

In view of the deficiencies of the prior art, it is an object of the present invention to provide an easy-to-use massager that can be used without holding by a hand by fitting a massage member to a human body part to be massaged, and being worn on a user's body by a connecting assembly.

In order to achieve the above object, the present invention provides the following technical solution.

An easy-to-use massager, includes: a massage member including a massage body and an annular body, where the massage body includes a massage portion and a massage potential energy generating device built in the massage portion, a surface of the massage portion is provided with a massage surface, and an inner periphery of the annular body is provided with an opening region; and a connecting assembly respectively connected with the massage body and the annular body to hold the massage member for massage by wearing by the connecting assembly; where the connecting assembly includes a connecting collar, a first connecting band connecting the massage body and the connecting collar; and a second connecting band connecting the annular body and the connecting collar; and the massage member further includes an elastic shell, the massage potential energy generating device and an opening-closing cover, an assembly cavity and an assembly opening provided on a surface of the elastic shell are provided in the elastic shell, the massage potential energy generating device is mounted in the assembly cavity through the assembly opening, and the opening-closing cover is detachably arranged on the massage potential energy generating device and closes the assembly opening.

By adopting the above technical solution, the following beneficial effects are achieved:
1. By fitting the massage member to a part to be massaged such as a woman's private part, palm or sole, and then sleeving the connecting collar on the appropriate part of the body, the massage member can be stabilized at the part to be massaged without holding by a hand in the presence of the connecting collar; and then the part to be massaged can be massaged by activating the massage member.
2. By operation of the massage body, the massage member causes the massage portion to act on the part to be massaged for massage. In addition, the massage member has the opening region on the inner periphery of the annular body, which allows the user to extend fingers and other massage tools into the opening region for massage, allowing for more diverse massage experience to improve comfort.
3. The first connecting band and the second connecting band extend the distance between the connecting collar and the massage member by means of their own length, so that the connecting collar is more stably connected to the body at a proper position. In addition, the first connecting band connects the massage body and the connecting collar, and the second connecting band connects the annular body and the connecting collar, in order to increase the distance between the first connecting band and the second connecting band to improve the stability of the connection.

### BRIEF DESCRIPTION OF THE DRAWINGS

FIG. 1 is an assembly diagram of a first embodiment of the present invention;

FIG. 2 is an assembly diagram of the first embodiment of the present invention;

FIG. 3 is an assembly diagram of a massage member in the first embodiment of the present invention;

FIG. 4 is an assembly diagram of the massage member in the first embodiment of the present invention;

FIG. 5 is an exploded view of the massage member in the first embodiment of the present invention;

FIG. 6 is a sectional view of the massage member in the first embodiment of the present invention;

FIG. 7 is an exploded view of a massage potential energy generating device in the first embodiment of the present invention;

FIG. 8 is a schematic diagram of an opening-closing member in the first embodiment of the present invention;

FIG. 9 is an assembly diagram of a second embodiment of the present invention;

FIG. 10 is an assembly diagram of a third embodiment of the present invention;

FIG. 11 is an assembly diagram of a fourth embodiment of the present invention;

FIG. 12 is an assembly diagram of a fifth embodiment of the present invention;

FIG. 13 is an assembly diagram of the fifth embodiment of the present invention;

FIG. 14 is an assembly diagram of a massage member in the fifth embodiment of the present invention;

FIG. 15 is a schematic diagram of an elastic shell in the fifth embodiment of the present invention;

FIG. 16 is an exploded view of a massage member in the fifth embodiment of the present invention;

FIG. 17 is a sectional view of the massage member in the fifth embodiment of the present

invention;

FIG. 18 is an exploded view of a massage potential energy generating device in the fifth embodiment of the present invention;

FIG. 19 is an assembly diagram of a sixth embodiment of the present invention;

FIG. 20 is an assembly diagram of a seventh embodiment of the present invention;

FIG. 21 is an assembly diagram of an eighth embodiment of the present invention; and

FIG. 22 is a use state diagram of the present invention.

### DESCRIPTION OF REFERENCE NUMERALS

1. massage member;
10. connecting assembly;
11. massage body; 12. annular body;
111. massage portion; 121. opening region;
1111. first massage convex strip; 1112. massage convex point; 1113. massage bump; 1114. massage surface;
2. connecting collar;
21. first connecting band; 22. second connecting band;
31. first connecting perforation; 32. second connecting perforation;
4. elastic shell;
41. assembly cavity; 42. assembly opening; 43. elastic pressing portion; 44. outwardly extending opening;
5. massage potential energy generating device;
51. connecting slot; 52. half shell member; 53. control board; 54. battery; 55. first vibration motor; 56. modular member; 57. massage column; 58. second vibration motor;
521. mounting insertion column; 531. control switch; 532. charging terminal; 571. mounting insertion hole; 572. wiring trough;
6. opening-closing cover;
61. connecting buckle;
7. elastic column sleeve;
71. annular convex portion; and 72. second massage convex strip.

### DESCRIPTION OF THE EMBODIMENTS

### First Embodiment

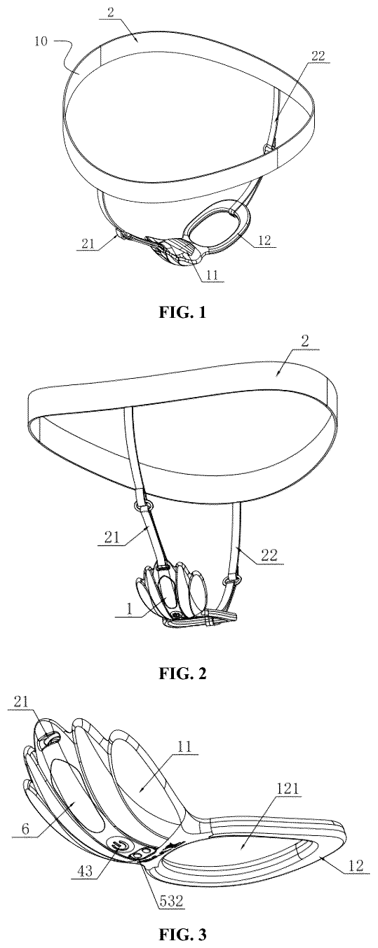

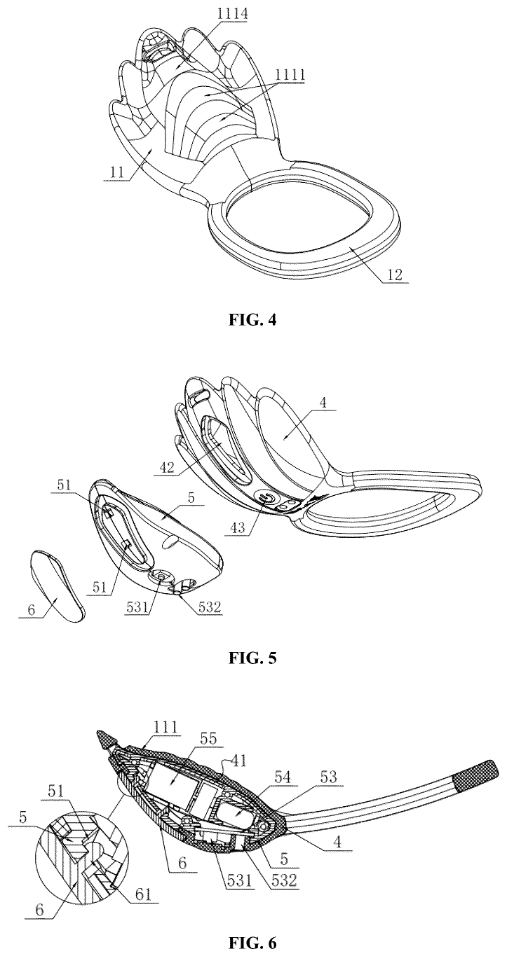

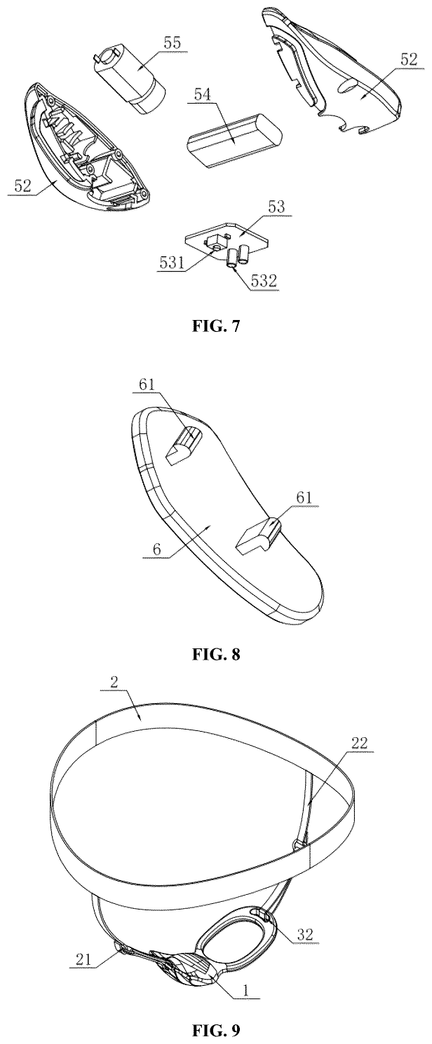

As shown in FIGS. 1-8, the present invention discloses an easy-to-use massager, including: a massage member 1 including a massage body 11 on a front side and an annular body 12 on a rear side, where the massage body 11 includes a massage portion 111 and a massage potential energy generating device 5 built in the massage portion 111, a surface of the massage portion 111 is provided with a massage surface 1114, and an inner periphery of the annular body 12 is provided with an opening region 121; and a connecting assembly 10 respectively connected with the massage body 11 and the annular body 12 to hold the massage member 1 for massage by wearing by the connecting assembly 10.

Specifically, the connecting assembly 10 includes a connecting collar 2, a first connecting band 21 and a second connecting band 22, and the connecting collar 2 is arranged above the massage member 1; the first connecting band 21 connects the massage body 11 and the connecting collar 2; and the second connecting band 22 connects the annular body 12 and the connecting collar 2.

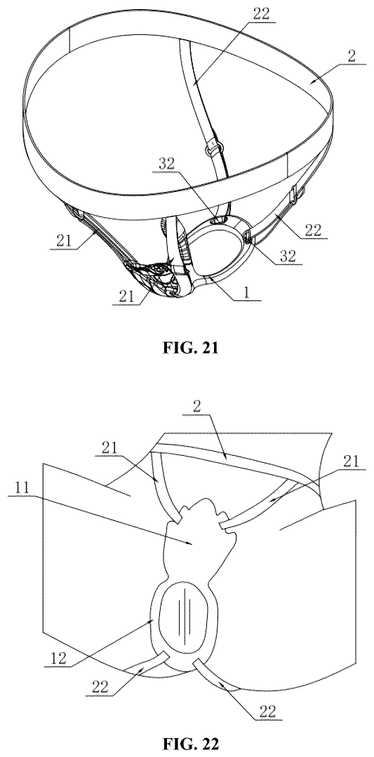

Therefore, by fitting the massage member 1 to a part to be massaged such as a woman's private part, and then sleeving the connecting collar 2 on the appropriate part of the body, the massage member 1 can be stabilized at the part to be massaged without holding by a hand in the presence of the connecting collar 2, realizing wearing of the massager as shown in FIG. 22, and then the part to be massaged can be massaged by activating the massage member 1. Specifically, the massage member 1, by activating the massage potential energy generating device 5, causes the massage portion 111 to act to massage the part to be massaged through the massage surface 1114 in contact with the part to be massaged, for example, vibration stimulates the clitoris to achieve massage. In addition, the massage member 1 has the opening region 121 on the inner periphery of the annular body 12, which allows a user to extend fingers and other massage tools such as a female masturbation stick into the opening region 121 to massage the part corresponding to the opening region 121, allowing for more diverse massage experience to improve comfort. Furthermore, operation of the massage potential energy generating device 5 also drives the annular body 12 to act, and the fingers or other massage tools in contact with the annular body 12 are driven to vibrate to optimize massage effect. Moreover, the transmission objects are human body parts such as fingers, so the human body parts can be vibrated for massage. Besides, the first connecting band 21 and the second connecting band 22 extend the distance between the connecting collar 2 and the massage member 1 by means of their own length, so that the connecting collar 2 is more stably connected to the body at a proper position. In addition, the first connecting band 21 connects the massage body 11 and the connecting collar 2, and the second connecting band 22 connects the annular body 12 and the connecting collar 2, in order to increase the distance between the first connecting band 21 and the second connecting band 22 to improve the stability of the connection.

This massager can also be used to massage palms or soles of feet.

Here, the connecting collar 2 may be an elastic rope so as to be fixed to the body by elastic contraction of the elastic rope to maintain stability, and may also be a buckle, a snap fastener, a hook-and-loop fastener and the like to adjust tightness.

Here, the first connecting band 21 and the second connecting band 22 may adopt an elastic rope, so that the lengths thereof can be adjusted through elastic expansion and contraction of the elastic rope, and therefore, the connecting collar 2 is sleeved at a suitable position; and the length can also be adjusted by means of a belt buckle, a snap fastener, a Velcro, or the like.

Specifically, in the present embodiment, the number of the first connecting band 21 is 1, and the number of the second connecting band 22 is 1; the massage body 11 is provided with a first connecting perforation 31 on a side away from the annular body 12; and the first connecting band 21 passes through the first connecting perforation 31 and is then positioned and mounted on the massage body 11, the second connecting band 22 passes through the opening region 121 and is then connected to the annular body 12, and the second connecting band 22 is located on a side of the annular body 12 away from the massage body 11.

Therefore, the stability of the assembly is further improved by providing the first connecting perforation 31 and the opening region 121 for the first connecting band 21 and the second connecting band 22 to pass through, and by positioning the first connecting band 21 and the second connecting band 22 on the sides where the massage body 11 and the annular body 12 are away from each other to increase the distance between the first connecting band 21 and the second connecting band 22, so that the massage member 1 is not easy to swing when the massager is in use.

Here, the massage member 1 in the present embodiment further includes an elastic shell 4 and an opening-closing cover 6; an assembly cavity 41 adapted to the shape and size of the massage potential energy generating device 5 is provided in the elastic shell 4, and a lower surface of the elastic shell 4 is provided with an assembly opening 42, so that the elastic shell 4 can expand the assembly opening 42 by deformation, and the massage potential energy generating device 5 is placed into the assembly cavity 41 when the assembly opening 42 is expanded to complete mounting, and the elastic shell 4 itself can be elastically contracted to enable an outer surface of the massage potential energy generating device 5 and the assembly cavity 41 to be tightly fitted. In addition, the opening-closing cover 6 is detachably arranged on the massage potential energy generating device 5 by means of a buckle structure, closes the assembly opening 42 when being assembled on the massage potential energy generating device 5 for sealing, and opens the assembly opening 42 when being removed from the massage potential energy generating device 5 to expose the massage potential energy generating device 5 to assemble and disassemble the massage potential energy generating device 5.

Here, the elastic shell 4 is made of a silicone material.

Specifically, two connecting buckles 61 are provided on one side of the opening-closing cover 6 facing the massage potential energy generating device 5, and two connecting slots 51 are correspondingly provided on the massage potential energy generating device 5, so that the opening-closing cover and the massage potential energy generating device are mounted together by means of cooperation between the connecting buckles 61 and the connecting slots 51.

Specifically, the massage potential energy generating device 5 in the present embodiment includes two half shell members 52 in plug-in combination, a control board 53 provided in the half shell member 52, a battery 54 and a first vibration motor 55; the control board 53 is provided with a control switch 531 and a charging terminal 532 extending out of the half shell member 52; the first vibration motor 55 and the battery 54 are respectively connected to the control board 53, so that the battery 54 provides electric energy for circuits; the battery 54 is charged by an external power supply connected to the charging terminal 532, and the first vibration motor 55 is turned on and off by pressing the control switch 531; and the first vibration motor 55 can drive the massage potential energy generating device 5 to vibrate, so that the vibrating massage potential energy generating device 5 transmits the vibration to the massage portion 111 to realize vibration for vibration massage.

Preferably, the elastic shell 4 is integrally formed with an elastic pressing portion 43 below the control switch 531, so that the control switch 531 is enclosed in the assembly cavity 41 to ensure sealing, and the elastic pressing portion 43 is pressed to press the control switch 531.

Here, the massage portion 111 in the present embodiment is in a convex strip shape. In addition, multiple first massage convex strips 1111 are arranged along a length direction on the massage portion 111, and each of the first massage convex strips 1111 is in a U-shaped structure. Therefore, the protrusion of the massage portion 111 and the protrusion of the plurality of first massage convex strips 1111 give rise to better massage effect when the massage body 11 vibrates.

### Second Embodiment

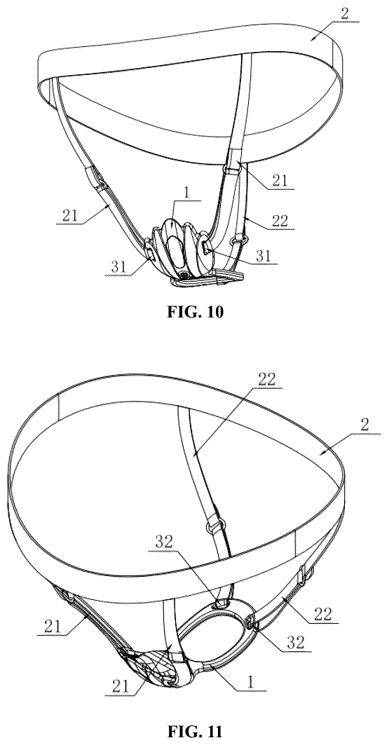

As shown in FIG. 9, the present embodiment discloses an easy-to-use massager which has a main structure the same as that of the first embodiment, except that the annular body 12 is provided with a second connecting perforation 32 on a side away from the massage body 11, allowing the second connecting band 22 to pass through the second connecting perforation 32 and is then positioned and mounted. At this time, the first connecting band 21 is stably mounted through the first connecting perforation 31, and the second connecting band 22 is stably mounted through the second connecting perforation 32. Therefore, connection positions are not easy to shift to ensure the comfort of use.

### Third Embodiment

As shown in FIG. 10, the present embodiment discloses an easy-to-use massager which has a main structure the same as that of the second embodiment, except that two first connecting perforations 31 are provided on a front side of the massage body 11 in a left-right symmetry at a certain distance; correspondingly, two first connecting bands 21 are provided, each of the first connecting bands 21 passes through the corresponding first connecting perforation 31, and each of the first connecting bands 21 is connected with the connecting collar 2 at a certain distance.

Therefore, the massage member 1 and the connecting collar 2 are connected by two first connecting bands 21 and one second connecting band 22, so that the massage member 1 is more stable and less prone to flipping in use.

### Fourth Embodiment

As shown in FIG. 11, the present embodiment discloses an easy-to-use massager which has a main structure the same as that of the third embodiment, except that two second connecting perforations 32 are provided on a rear side of the annular body 12 in a left-right symmetry at a certain distance; correspondingly, two second connecting bands 22 are provided, each of the second connecting bands 22 passes through the corresponding second connecting perforation 32, and each of the second connecting bands 22 is connected with the connecting collar 2 at a certain distance.

Therefore, the massage member 1 and the connecting collar 2 are connected by two first connecting bands 21 and two second connecting bands 22, so that the massage member 1 is more stable and less prone to flipping in use.

### Fifth Embodiment

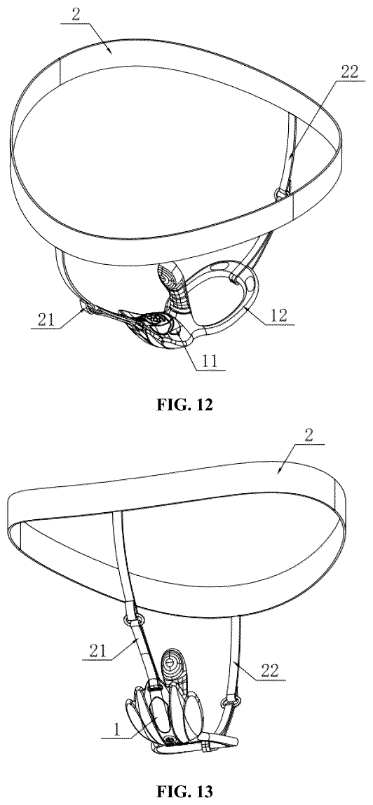

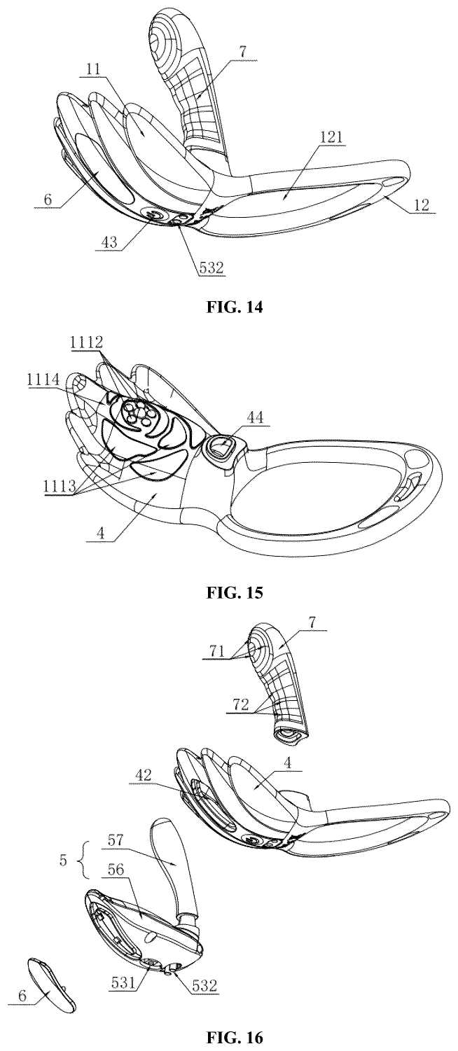

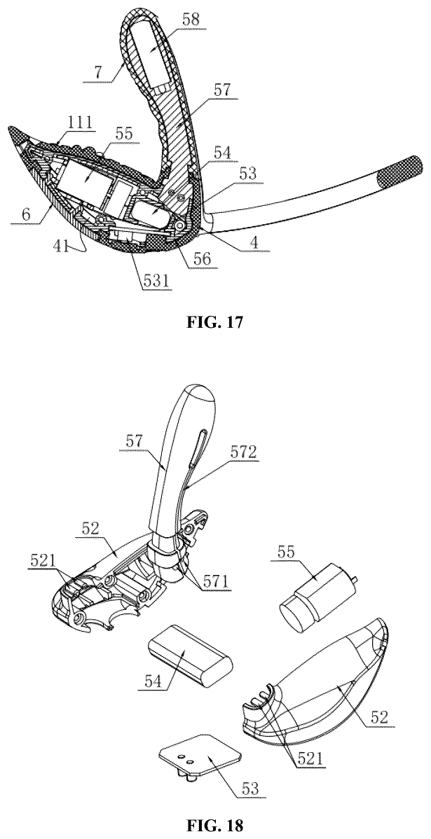

As shown in FIGS. 12-18, the present embodiment discloses an easy-to-use massager which has a main structure the same as that of the first embodiment, except that the massage potential energy generating device 5 includes a modular member 56 and a massage column 57, one end of the massage column 57 is connected to an upper rear side of the modular member 56, and the other end of the massage column 57 extends upwards, so that the massage portion 111 and the massage column 57 are located on a same side of the massage body 11.

Specifically, the modular member 56 in the present embodiment includes two half shell members 52 in plug-in combination, a control board 53 provided in the half shell member 52, a battery 54 and a first vibration motor 55; the control board 53 is provided with a control switch 531 and a charging terminal 532 extending out of the half shell 52; the first vibration motor 55 and the battery 54 are respectively connected to the control board 53, so that the battery 54 provides electric energy for circuits; the battery 54 is charged by an external power supply connected to the charging terminal 532, and the first vibration motor 55 is turned on and off by pressing the control switch 531; and the first vibration motor 55 can drive the modular member 56 to vibrate, so that the vibrating modular member 56 transmits the vibration to the massage portion 111 to realize vibration for vibration massage. In addition, two mounting insertion holes 571 penetrating from left to right are provided at a lower end of the massage column 57; correspondingly, each of the half shell members 52 is provided with a mounting insertion column 521 inserted into each of the mounting insertion holes 571, so that the half shell members 52 are inserted into the mounting insertion holes 571 through the mounting insertion columns 521 when assembled with each other to be mounted on the modular member 56. Moreover, a second vibration motor 58 is provided in an upper end of the massage column 57, and an outer periphery of the massage column 57 is provided with a wiring trough 572, so that the second vibration motor 58 and the control board 53 are connected by a wire, and the wire is built in the wiring trough 572, so that the second vibration motor 58 is turned on and off by pressing the control switch 531. The second vibration motor 58 can drive the massage column 57 to vibrate for massage.

Here, in the present embodiment, the massage column 57 can be inserted into the vagina of a woman to massage the vagina of the woman by vibration, and can also perform massage on the prostate to achieve the purpose of health preservation.

In addition, the massage member 1 further includes an elastic column sleeve 7, the elastic shell 4 is provided with an outwardly extending opening 44 for the massage column 57 to penetrate, and the elastic column sleeve 7 is sleeved on an outer periphery of the massage column 57 and closes the outwardly extending opening 44.

Therefore, when the massage member 1 is assembled, the modular member 56 and the massage column 57 are mounted through the assembly opening 42, then the massage column 57 is extended through the outwardly extending opening 44, and the elastic shell 4 is contracted and tightly fitted to the modular member 56, and then the elastic column sleeve 7 is sleeved on the outer periphery of the massage column 57 to close the outwardly extending opening 44, and the opening-closing member is fitted to the modular member 56 to close the assembly opening 42, thus improving the comfort of use through contact between the elastic shell 4 and elastic column sleeve 7 and the body while ensuring sealing.

Here, the massage portion 111 is in a convex strip shape, and a top portion of the massage portion 111 is provided with massage convex points 1112 and massage bumps 1113, so that the massage convex points 1112 perform vibration massage in a point massage manner, and the massage bumps 1113 perform vibration massage in a surface massage manner, improving the comfort of massage.

Preferably, the number of the massage convex points 1112 in the present embodiment is multiple, specifically 6, with one massage convex point 1112 centered, and the other five massage convex points 1112 surrounding an outer periphery of the centered massage convex point 1112 to form an array.

In other embodiments, the massage convex points 1112 may also be linearly arranged.

Preferably, the number of the massage bumps 1113 in the present embodiment is multiple, and the massage bumps 1113 surround the outer peripheries of the massage convex points 1112 to provide more comfortable massage by the multiple massage bumps 1113.

Here, one side of a top portion of the elastic column sleeve 7 is provided with multiple annular convex portions 71 arranged radially, and one side of a middle portion of the elastic column sleeve 7 is provided with second massage convex strips 72 arranged along a length direction of the elastic column sleeve 7, so that the massage comfort of the elastic column sleeve 7 is improved through the annular convex portions 71 and the second massage convex strips 72.

### Sixth Embodiment

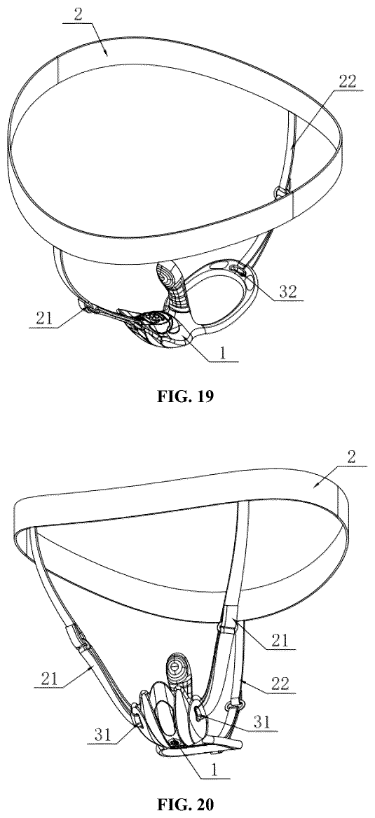

As shown in FIG. 19, the present embodiment discloses an easy-to-use massager which has a main structure the same as that of the fifth embodiment, except that the annular body 12 is provided with a second connecting perforation 32 on a side away from the massage body 11, allowing the second connecting band 22 to pass through the second connecting perforation 32 and is then positioned and mounted. At this time, the first connecting band 21 is stably mounted through the first connecting perforation 31, and the second connecting band 22 is stably mounted through the second connecting perforation 32. Therefore, connection positions are not easy to shift to ensure the comfort of use.

### Seventh Embodiment

As shown in FIG. 20, the present embodiment discloses an easy-to-use massager which has a main structure the same as that of the sixth embodiment, except that two first connecting perforations 31 are provided on a front side of the massage body 11 in a left-right symmetry at a certain distance; correspondingly, two first connecting bands 21 are provided, each of the first connecting bands 21 passes through the corresponding first connecting perforation 31, and each of the first connecting bands 21 is connected with the connecting collar 2 at a certain distance.

Therefore, the massage member 1 and the connecting collar 2 are connected by two first connecting bands 21 and one second connecting band 22, so that the massage member 1 is more stable and less prone to flipping in use.

### Eighth Embodiment

As shown in FIG. 21, the present embodiment discloses an easy-to-use massager which has a main structure the same as that of the seventh embodiment, except that two second connecting perforations 32 are provided on a rear side of the annular body 12 in a left-right symmetry at a certain distance; correspondingly, two second connecting bands 22 are provided, each of the second connecting bands 22 passes through the corresponding second connecting perforation 32, and each of the second connecting bands 22 is connected with the connecting collar 2 at a certain distance.

10 Therefore, the massage member 1 and the connecting collar 2 are connected by two first connecting bands 21 and two second connecting bands 22, so that the massage member 1 is more stable and less prone to flipping in use.

What is claimed is:

1. An easy-to-use massager, comprising:
a massage member comprising a massage body and an annular body, the massage body comprising a massage portion and a massage potential energy generating device built in the massage portion, a surface of the massage portion being provided with a massage surface, and an inner periphery of the annular body being provided with an opening region; and
a connecting assembly respectively connected with the massage body and the annular body to hold the massage member for massage by wearing by the connecting assembly;
wherein the connecting assembly comprising:
a connecting collar;
a first connecting band connecting the massage body and the connecting collar; and
a second connecting band connecting the annular body and the connecting collar; and
the massage member further comprises an elastic shell and an opening-closing cover, an assembly cavity and an assembly opening provided on a surface of the elastic shell are provided in the elastic shell, the massage potential energy generating device is mounted in the assembly cavity through the assembly opening, and the opening-closing cover is detachably arranged on the massage potential energy generating device and closes the assembly opening.

2. The easy-to-use massager according to claim 1, wherein the first connecting band is connected to a side of the massage body away from the annular body.

3. The easy-to-use massager according to claim 1, wherein the second connecting band is connected to a side of the annular body away from the massage body.

4. The easy-to-use massager according to claim 1, wherein the massage body is provided with a first connecting perforation for the first connecting band to pass through.

5. The easy-to-use massager according to claim 1, wherein the annular body is provided with a second connecting perforation for the second connecting band to pass through.

6. The easy-to-use massager according to claim 1, wherein the second connecting band passes through the opening region.

7. The easy-to-use massager according to claim 4, wherein the number of the first connecting perforations is multiple, and the number of the first connecting bands is the same as the number of the first connecting perforations.

8. The easy-to-use massager according to claim 5, wherein the number of the second connecting perforations is multiple, and the number of the second connecting bands is the same as the number of the second connecting perforations.

9. The easy-to-use massager according to claim 1, wherein a first vibration motor is provided in the massage potential energy generating device to drive the massage potential energy generating device to vibrate by the vibration of the first vibration motor.

10. The easy-to-use massager according to claim 9, wherein the massage potential energy generating device comprises a modular member and a massage column, one end of the massage column is connected to the modular member, and the massage portion and the massage column are located on a same side of the massage body.

11. The easy-to-use massager according to claim 10, wherein the first vibration motor is provided in the modular member to drive the modular member to vibrate by the vibration of the first vibration motor.

12. The easy-to-use massager according to claim 10, wherein a second vibration motor is provided in the massage column to drive the massage column to vibrate by the vibration of the second vibration motor.

13. The easy-to-use massager according to claim 10, wherein the massage member further comprises an elastic column sleeve, the elastic shell is provided with an outwardly extending opening for the massage column to penetrate, and the elastic column sleeve is sleeved on an outer periphery of the massage column and closes the outwardly extending opening.

14. The easy-to-use massager according to claim 13, wherein one end of the elastic column sleeve away from the elastic shell is provided with multiple annular convex portions arranged radially, and a middle portion of the length of the elastic column sleeve is provided with second massage convex strips arranged along a length direction of the elastic column sleeve.

15. The easy-to-use massager according to claim 1, wherein the massage portion is arranged in a convex strip shape, multiple first massage convex strips are arranged along a length direction on the massage portion, and each of the first massage convex strips is in a U-shaped structure.

16. The easy-to-use massager according to claim 1, wherein the massage portion is arranged in a convex strip shape, and a top portion of the massage portion is provided with massage convex points and/or massage bumps.

17. The easy-to-use massager according to claim 16, wherein the massage convex points are multiple in number, and the massage convex points are arranged linearly or in an array.

18. The easy-to-use massager according to claim 16, wherein the massage bumps are multiple in number, and each of the massage bumps surrounds an outer periphery of the massage convex point.
